(19) United States
(12) Patent Application Publication
(10) Pub. No.: US 2006/0222806 A1
(43) Pub. Date: Oct. 5, 2006

(54) Novelty stick-on facial feature

(76) Inventor: Donald K. Burchett, Louisville, KY (US)

Correspondence Address: WOOD, HERRON & EVANS, LLP, 2700 CAREW TOWER, 441 VINE STREET, CINCINNATI, OH, 45202, US

(21) Appl. No.: 11/098,801

(22) Filed: Apr. 5, 2005

(51) Int. Cl. B32B 3/02

(52) U.S. Cl. 428/64.1

(57) ABSTRACT

A glow-in-the-dark facial feature includes a casing holding a chemiluminescent substance. The surface of the facial feature has opaque or translucent portions. The backside has a fastening mechanism. Preferably, the facial features include glow-in-the-dark eyes. Such glow-in-the-dark eyes include a casing which supports a chemiluminescent material and further includes an opaque or translucent portion simulating the pupil of an eye. These can adhere to a structure such as an inflated balloon with a pressure sensitive adhesive.

### BACKGROUND OF THE INVENTION

Inanimate objects are frequently decorated with human or animal features. In particular, facial features and characteristics can be used on inanimate objects such as novelty characters, decorations, bags, such as Halloween bags, and the like. Other examples include ghost figures or animal figures used for decoration. It is desirable to use new and creative means to create such creatures.

### SUMMARY OF THE INVENTION

The present invention is premised on the realization that inexpensive novelty stick-on eye features, and other facial features, can be formed by utilizing a glow-in-the-dark chemiluminescent product. In particular, the chemiluminescent device is a generally planar case which holds a reactive liquid and includes a frangible capsule of a second liquid which, when combined, create light chemiluminescently. The casing is formed in the shape of an eye, or other facial feature, with an outer generally transparent or translucent surface. A portion of the front facing would be covered with something to indicate a portion of the facial feature, such as a pupil of an eye.

In alternate embodiments of the present invention, the facial feature can also include translucent portions which, combined with the light from the emitting device, emits a different color.

The facial feature can also have light scattering plastic members attached to the casing to scatter light.

The device may include a pressure sensitive adhesive layer which enables it to be attached to a variety of different surfaces such as balloons, paper bags, and the like. Other means of attachment can be used such as hook and pile fastening or a pin, or the like. Thus, it can be attached to virtually any structure.

The objects and advantages of the present invention will be further appreciated in light of the following detailed description and drawings in which:

### BRIEF DESCRIPTION OF THE DRAWINGS

FIG. 1 is a perspective view of the present invention;

FIG. 2 is a perspective view of the novel eye of the present invention;

FIG. 2A is a cross sectional view taken at lines 2a of FIG. 2;

FIG. 2B is an elevational view of a second alternate embodiment of the eye shown in FIG. 2;

FIG. 2C is an elevational view of a third alternate embodiment of the present invention.

FIG. 3 is a perspective view of an alternate embodiment of the present invention.

### DETAILED DESCRIPTION OF THE INVENTION

The present invention is a glow-in-the-dark facial feature. This can be an eye, mouth, ears, or nose. Preferably, the facial feature is an eye.

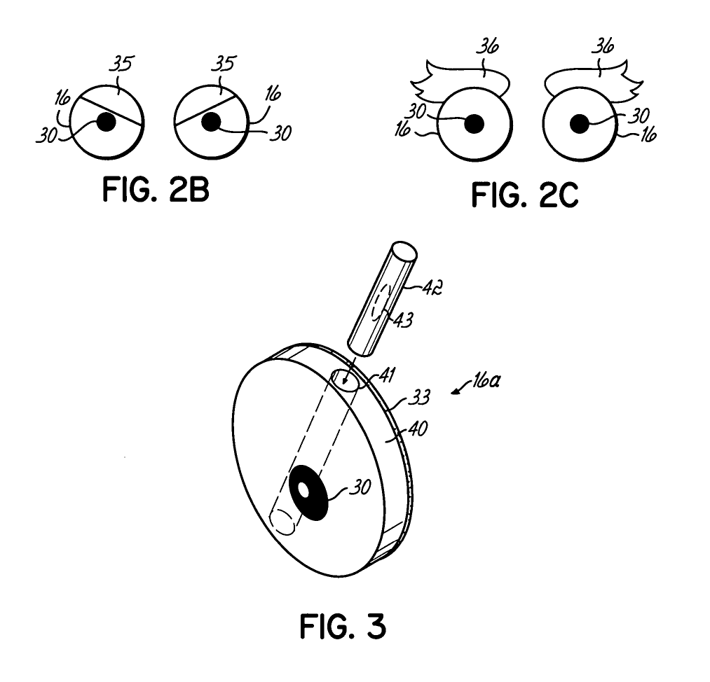

The eye 16, as shown in FIGS. 2 and 2A, includes a sealed casing 26 which holds a first reactive fluid 27 and a frangible capsule 28. The casing 26 is formed from a general flexible plastic. The forward surface 31 of casing 26 is generally clear. The back side 34 of the casing includes an adhesive layer 32 covered with a release paper 33.

Frangible capsule 28 holds a second reactive fluid. The casing 26 is sealed and is sufficiently flexible to allow one to press against the capsule 28 and break it, causing the fluid in the capsule to mix with the fluid 27 in the casing thereby causing the two fluids to react and emit light. Such chemiluminescent materials are very well known. One, for example, is disclosed in Dorney U.S. Pat. No. 6,748,681, the disclosure of which is incorporated herein by reference.

The eye 16 further includes an opaque member 30 which is in the shape of a pupil. This is adhered to, or painted on, surface 31 of the casing.

The member 30 in the shape of a pupil may be made of a colored, translucent material instead of an opaque material. For example, on an eye, which contains chemiluminescent reagents that produce a yellow colored light, the pupil 30 may be made from a translucent blue plastic film. The yellow light passing through the blue film produces a pupil, which appears to be colored green. It is obvious to one skilled in the art that various combinations of chemiluminescent light color and transparent film color could be used to produce wide variety of interesting and decorative eyes under the present invention.

In addition, as shown in FIG. 2B, translucent plastic material 35 may be placed over a part of the eye 16 to form an eyelid of a different color.

In yet another variation of this invention, translucent, light-scattering plastic film 36 may be placed at the edge of the eye 16, slightly overlapping it, to form an eyebrow which is illuminated by light which is picked up from the chemiluminescent source by the light-scattering material. An example of this is shown in FIG. 2C.

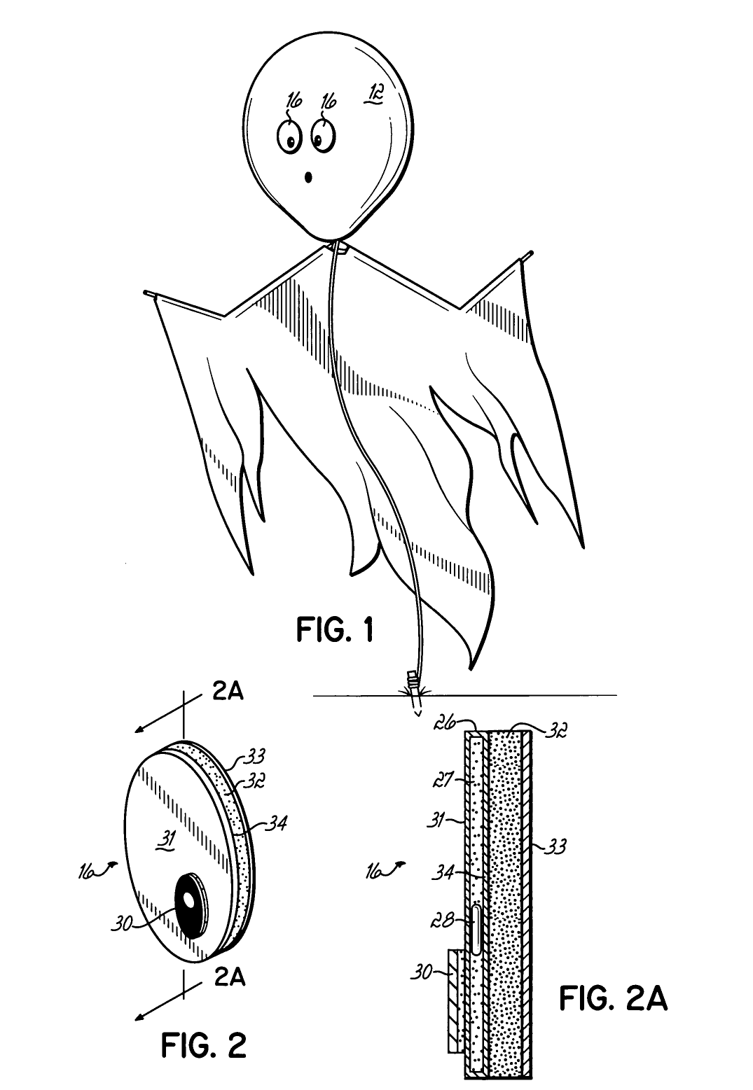

The eye 16 is applied to a surface, such as a balloon 12, shown in FIG. 1, by removing the release paper 33 and pressing the adhesive 32 against the surface of the inflated balloon 12. Although not shown in the figures, the pressure sensitive adhesive 32 can be replaced by a variety of different attachment mechanisms. For example, a pin can be used if the eye is to be affixed to wood. A hook and pile fastener can be used, as well as a magnet or any type of clip. But in light of the transient nature of the light emission, pressure sensitive adhesion is the preferred fastening mechanism.

An alternate embodiment of the present invention is shown in FIG. 3. In this embodiment, the eye 16a is a transparent disc 40 with a cylindrical central passage 41. A light emitting rod 42, similar to those used in glow-in-the-dark golf balls, is inserted into the disc 40 to provide the light. In this embodiment, the disc 40 acts as the casing, and the first reactive fluid as well as the frangible capsule 43 with the second reactive fluid are contained in the rod 42.

The chemiluminescent eyes of this invention may also be applied to a variety of surfaces in addition to balloons. For example, they may be placed on a bag used for trick-or-treating to provide added safety, making the user more visible in the dark. They may also be adhered to masks, clothing, doors, hats, etc.

Accordingly, the present invention, which has been previously described should be defined only by the appended claims, wherein we claim:

1. Glow-in-the-dark facial features comprising a casing holding a first reactive fluid and a frangible capsule said frangible capsule containing a second reactive fluid wherein said first and second fluids react to emit light;
said casing is in the shape of a facial feature; and
said casing is transparent on a first side and on a second side includes an attachment mechanism.

2. The glow-in-the-dark facial feature claimed in claim 1 wherein said facial feature is in the shape of an eye and wherein said transparent surface of said casing is partially covered with an opaque member said opaque member being in the shape of a pupil.

3. The glow-in-the-dark facial features claimed in claim 1 wherein said casing is partially covered with an opaque member.

4. The glow-in-the-dark facial features claimed in claim 1 further comprising a translucent member on a portion of said first side.

5. A glow-in-the-dark eye comprising a light emitting chemiluminescent disc having a first side and a second side, said first side having indicia depicting a pupil, and said back side having an attachment mechanism.

6. The glow-in-the-dark eye claimed in claim 5 wherein said attachment mechanism is a pressure sensitive adhesive.
